(19) United States
(12) Patent Application Publication
(10) Pub. No.: US 2005/0195794 A1
(43) Pub. Date: Sep. 8, 2005

(54) Switching device and method for error analysis

(76) Inventor: Sandor Szekely, Neubiberg (DE)

Correspondence Address: SIEMENS CORPORATION;INTELLECTUAL PROPERTY DEPARTMENT, 170 WOOD AVENUE, SOUTH, ISELIN, NJ, 08830, US

(21) Appl. No.: 11/035,719

(22) Filed: Jan. 15, 2005

(30) Foreign Application Priority Data
Jan. 16, 2004 (DE) 10 2004 002 452.9

(51) Int. Cl. H04L 12/28

(52) U.S. Cl. 370/351; 370/401

(57) ABSTRACT

Switching device and method for error analysis In the present switching device and the method for error analysis pertaining thereto, message signals for identical message types from a plurality of call requests are combined in a message type representative and, according to the respective occurrence of the message types, a time stamp for the message signal is assigned to the respective message type representative. A plurality of message type representatives shown in a population diagram having time stamps pertaining thereto can be supplied to a population analysis module for selective troubleshooting.

### CROSS REFERENCE TO RELATED APPLICATIONS

This application claims priority to the German application No. 10 2004 002 452.9, filed Jan. 16, 2004 and which is incorporated by reference herein in its entirety.

### FIELD OF INVENTION

The invention relates to a switching device and method for error analysis.

### BACKGROUND OF INVENTION

With increasing interconnection-of telecommunications networks involving various technologies, such as, for example, Time Division Multiplex technology and Internet protocol technology, the tracking of signal data and/or data streams within or between networks by a developer or operator is becoming more and more difficult.

Existing methods for error analysis allowed the display of individual signal data and/or data streams between a data source and a data sink according to the occurrence thereof at a test point. Such a display represents individual signaling sequences during a request for a call setup and/or call cleardown. The signaling for the call setup comprises, for example, message types such as Setup, Call Proceeding, Connect and Connect Acknowledge, and message types such as Release REL and Release Complete RLC for signaling during a call cleardown.

Trouble-shooting or fault localization comes up against limiting factors with respect to the aforementioned display of signaling sequences and/or data streams, if for example, a plurality of call requests are to be displayed.

With existing devices, it was merely possible to comprehend the results of a test-run after the input of a vast amount of time. The display became very unmanageable and therefore unusable if the signal data from a plurality of call requests were to be displayed and evaluated over a fairly long period. Furthermore, the existing devices and the methods pertaining thereto had the drawback that fluctuations in the signal traffic or in the Real-time Transport Protocol RTP were not comprehensible.

### SUMMARY OF INVENTION

The object of the invention is to provide a further switching device and a method pertaining thereto for the display of signal data for signal traffic during a call setup, call cleardown or during a data transfer.

This object is achieved by the Claims.

The invention has the advantage that a plurality of directly consecutive signal data or data streams can be classified and analyzed.

The invention has the advantage that test runs over a number of hours/days can still be analyzed.

The invention has the advantage that signal data from a plurality of call requests can be analyzed without the input of a fairly vast amount of time.

The invention has the advantage that a plurality of directly consecutive signals from a plurality of call requests can be analyzed together.

The invention has the advantage that a plurality of interfaces can be analyzed concurrently.

The invention has the advantage that network errors and irregularities in the signaling can be detected using minimal hardware and software.

Further particular features of the invention will become clear from the following explanations relating to the figures that show embodiments by means of schematic diagrams.

### BRIEF DESCRIPTION OF THE DRAWINGS

The figures show:

FIG. 1a schematic diagram of an analysis module,

FIG. 2a data flow graph pertaining thereto,

FIG. 3a further schematic diagram of an analysis module,

FIG. 4 a population diagram pertaining thereto,

FIG. 5 a metapopulation diagram from data streams at two interfaces along a connection pathway,

FIG. 6 a further metapopulation diagram,

FIG. 7 a section of a network topology,

FIG. 8 a metapopulation diagram pertaining thereto having a plurality of protocol types and message types pertaining thereto and

FIG. 9 a further metapopulation diagram having a plurality of protocol types and message types pertaining thereto.

### DETAILED DESCRIPTION OF INVENTION

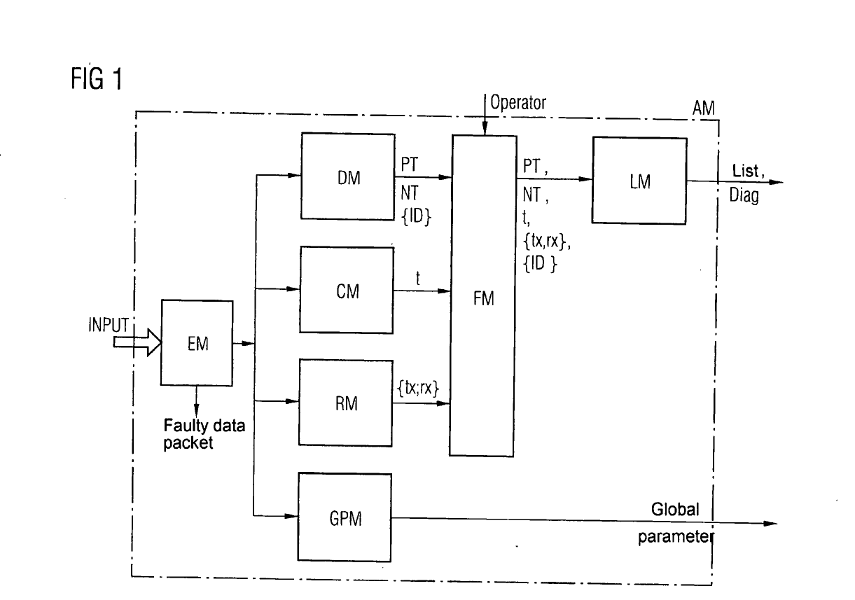

FIG. 1 shows a schematic diagram of the design of a switching device for analyzing and representing signal traffic during a call setup, a data transfer and a call cleardown.

At the input end, the data analysis module AM that is shown is bombarded, for example, with a data stream extracted from an interface. Each data stream is formed of packetized data. After it has passed through an error detection module EM that is arranged in the analysis module AM at the input end, the output signal from the error detection module EM is directed to further modules DM, CM, RM, GPM for processing. The data packets from the data stream at the input end of the error detection module EM, which have been tested for bit error-free packet transmission, are redirected to a decoding module DM, a clock extraction module CM and a direction detection module RM.

From the data likewise supplied in each data packet the decoding module DM calculates the protocol type PT, the message type NT and the identification number ID. The protocol type PT combines, for example, the data protocols used during a data transport, such as, for example, Q.931 for ISDN signaling or an MGCP data protocol for a Media Gateway Control protocol. The message type NT combines, for example, the data for signaling setup and cleardown such as Setup, Call Proceeding, Connect, Connect Acknowledge and so on. The identification number ID refers to the respective assignment of the message type to a call setup. In the clock recovery module CM, a time stamp t supplied with the respective data packet is extracted. The direction detection module RM determines whether the globalization parameter module data stream is a receive signal rx or a transmit signal tx.

Furthermore, a globalization parameter module GPM is customary for the statistical analysis of the data stream at the input end of the analysis module AM. The globalization parameter module GPM can for example, detect data such as Errored Packets in Blocks, Packet Error Rate and/or Call Failure Rate CFR.

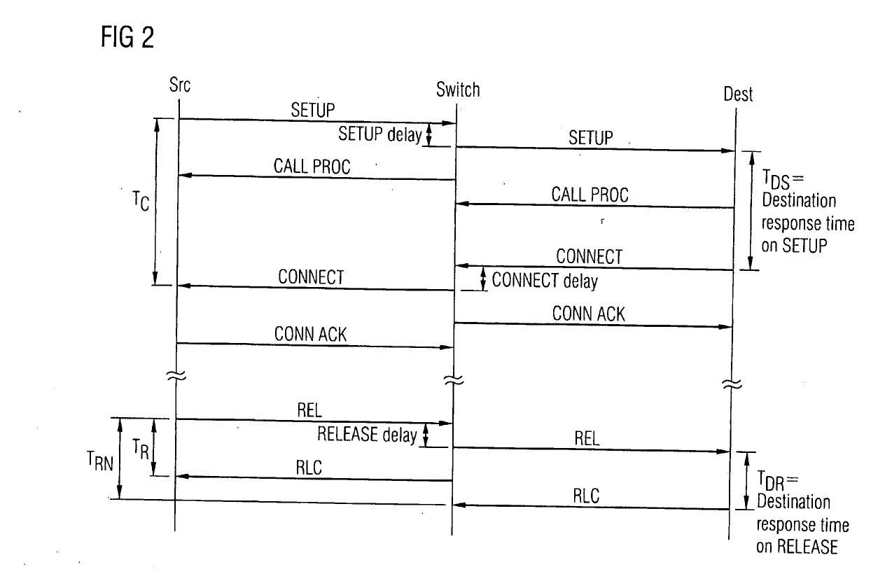

The output signals from the decoding module DM, the clock extraction module CM and a direction detection module RM are further directed at the input end to a filter module FM. The signal data/data signals selected by the filter module FM are transmitted to a list module LM. The aforementioned data, which are temporarily stored in the list module, can be reproduced as shown in FIG. 2.

FIG. 2 shows a signaling setup and cleardown between a first telecommunications unit SRC, triggering a call signal, and a second telecommunications unit, shown as DEST. The telecommunications pathway runs through a switching node SW.

The call is requested via a message signal NT Setup. The Setup message signal is acknowledged by a Call Proceeding in the switching node SW and in the second telecommunications unit. A Connect signal is sent by the second telecommunications unit to the first telecommunications unit after a period of time shown as T(DS). An acknowledgement is then sent by both the switching node SW and the first telecommunications unit SRC via a Connect Acknowledge Signal.

The communications pathway is then cleared by a Release REL signal. This is then repeated in each case using a Release Complete signal RLC. Said message signals are also referred to hereafter as data signals and data types.

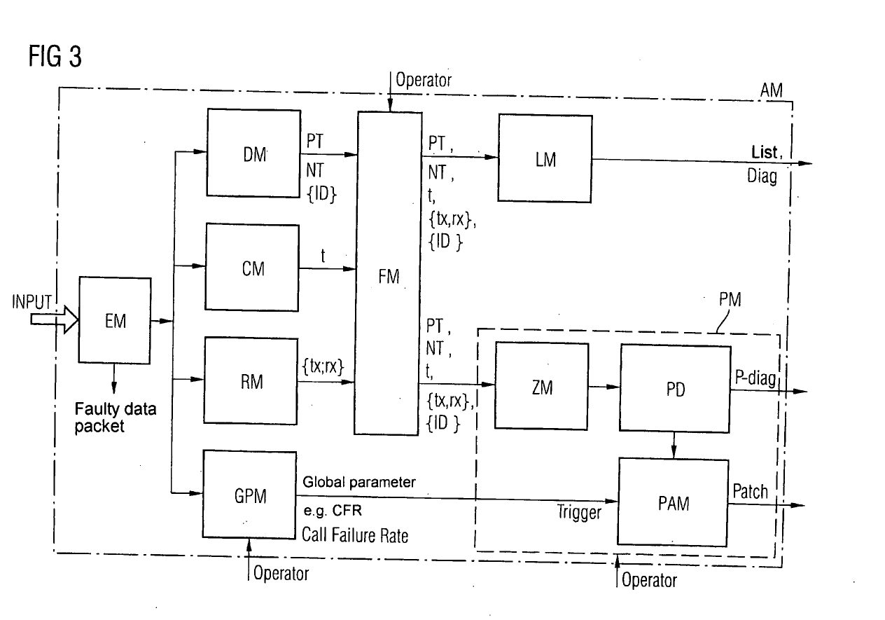

FIG. 3 shows a further configuration of the data analyzer AM. According to the invention, the device that has already been partly described in FIG. 1 is provided with a module referred to as a population module PM. In the filter module FM, subsets can be selected from the data signals PT, NT, ID, t, tx, rx at the inputs. In the subsets the available signal data/data signals can then be combined and displayed using various strategies for selective observation. The above focusing can then concentrate on a certain selection of identification numbers from IDx to IDy or a certain observation of a time window between the time stamps “ta” to “te”. Similarly it is possible to select only those signals sent by one data source or received by one data sink. Additionally, the search for errors can be restricted to a certain number of significant protocols PT or message types NT. Said subsets can be created in the filter module FM using software, firmware, hardware or manual input by an operator. The population module PM is made up of an assignment module ZM, a population diagram module PD and a population sample analysis module PAM. The module referred to as assignment module ZM provides temporary storage of the data that are extracted by the filter module FM and combined with a representative. In this table the respective message signals NT extracted from the data packets at the input end in the data analysis module are assigned to a population level. In the assignment of signals, the message signal for the message type SETUP is assigned for example to a first level, the message signal for the message type Call Proceeding is assigned on a second level, and subsequent message types at a third, then fourth level and so on. The individual levels can be assigned additionally to a first and second sublevel according to the direction of the signal. Thus the first sublevel for outgoing message signals for a transmit signal tx and the second sublevel for received message signals, such as receive signals rx, can be shown on different axes. The individual levels can also be described as representatives.

Assignment of the temporarily stored signal data/data can be achieved by, for example, assigning a sublevel to a numerical operator e.g. 10 for the first level SETUP, 20 for the second level Call Proceeding and so on. A similar procedure can be used for a sublevel. Thus an operator of 10+1=11 can be assigned to the first sublevel, for example for a transmitted data signal such as SETUP, and a further operator 10−1=9 can be assigned to a second sublevel for a received data signal.

The message signals from individual or from a plurality of call requests, which were temporarily stored in the tables, are combined in a display unit PD assigned to the population module PM, and each is shown marked with a time stamp t. In a population sample analysis module PAM, which is assigned to the population module PM, sample detection assisting the error detection process can be selected for control purposes.

Using data extracted by the globalization module GPM, the data redirected by the assignment module ZW and the population diagram module PD can be triggered for example in the population sample analysis module PAM. An automatic startup of a sample analysis is possible through the output signal where there is a sporadically occurring error, such as that encountered, for example, during a short time window. This offers the advantage that sporadically occurring errors, for example where there is an increase in a Call Failure Rate, can be signaled using a predeterminable boundary value.

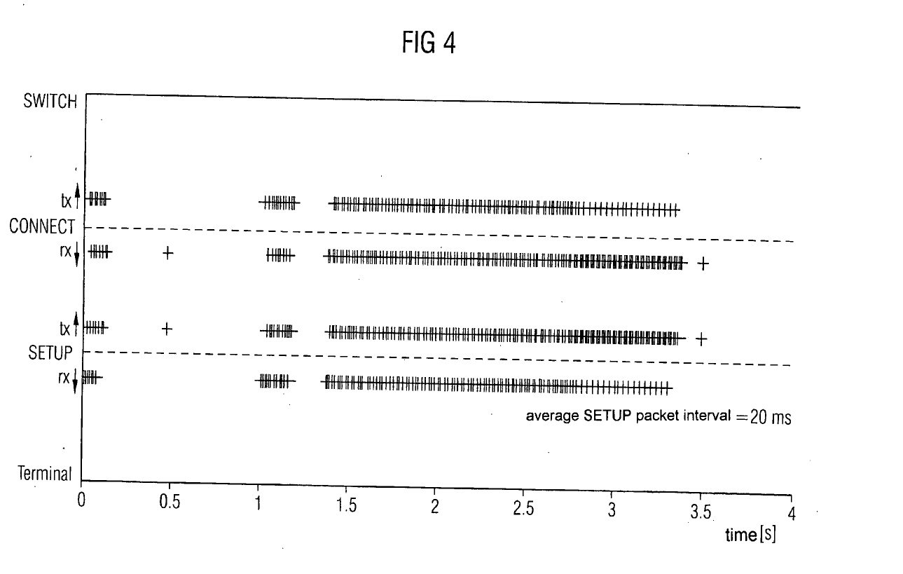

The horizontal axis of a message type representative shows message signals according to their occurrence during a signaling procedure between a data source and data sink, see FIGS. 4, 5, 6, 8, and 9. Where signal sequences are displayed for a plurality of message connection requests, identical message signals are combined. For a plurality of setup message signals, for example, there is still only one message signal representative shown. The aforementioned message type, only one of which is shown in each case, can also be referred to as a representative, data representative or message type representative.

FIG. 4 shows the assignment of a set of data combined in an assignment module ZM. The display is achieved via the population diagram module PD. The aforementioned diagram shows a data type representative in a first and second population level. A message signal is shown, for example, by a vertical line marked on the horizontal axis, according to its time stamp. Additionally, an identification number can be assigned to said time stamp. Listing the types of message signals together with their identification numbers is likewise possible. In the present diagram, two message signals are denoted by the respective message representatives SETUP and CONNECT, each message type representative being shown by two respective sublevels relating to an interface between a terminal and a network element. In the present diagram, the call requests are restricted to a lower number. The outgoing call request from the terminal generates a message signal of the message type SETUP in the terminal. Said message signal is shown by a vertical line on the axis for the signaling representative SETUP (tx). Each entry for a time stamp is recorded by a vertical line along this axis. Said time stamp is a representative of a respective call request.

A response from the partner in the communication is shown by a horizontal line on the SWITCH in CONNECT (rx) axis. For each signal that is received by the terminal, a message signal of the message type SETUP is shown on the axis for the SETUP-representative SETUP (rx). The CONNECT message signals generated by the terminal are likewise represented along the sublevel on the axis for the message representative CONNECT (tx) by a vertical line, for example, according to the time of occurrence.

FIG. 4 shows error-free signal traffic between the telecommunications subscribers. The figure shows the respective frequency and distribution of the message signals of the message type SETUP tx, rx, CONNECT tx, rx on the message type representative that has been generated.

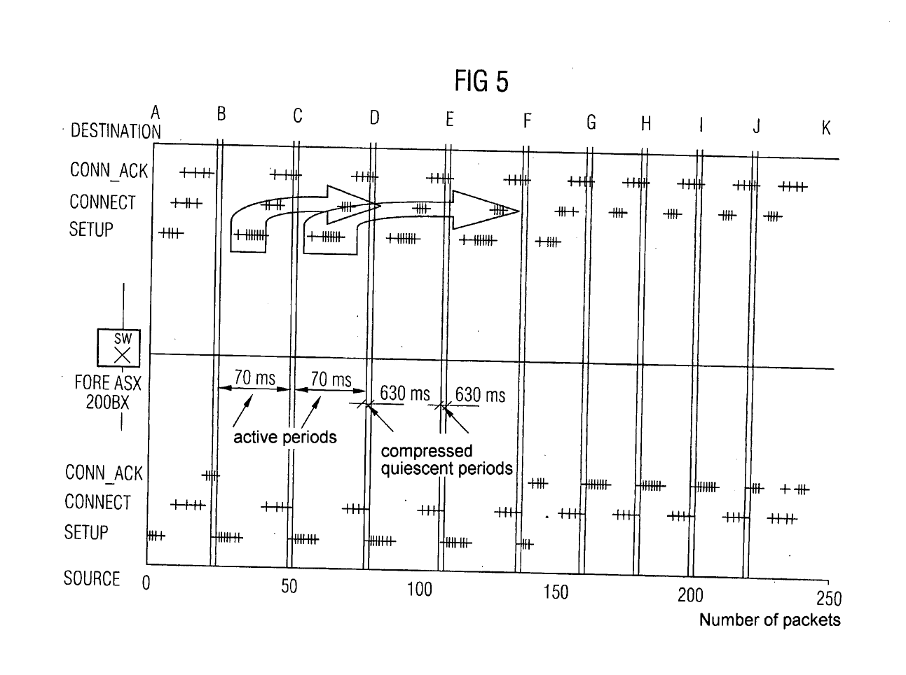

FIG. 5 shows a metapopulation diagram MPD (x;y;u;v), x representing the number of interfaces between the SOURCE module and the SW module and likewise between the SW module and the DESTINATION module, y being the number of protocol types, u the number of message types and v the number of sublevels. FIG. 5 thus shows a metapopulation diagram MPD (2;1;3;1).

In a first section A-B, this diagram shows error-free signal traffic. As shown in FIG. 2, there is the same sequence of message signals between SOURCE and SWITCH SW as between SWITCH SW and DESTINATION. The aforementioned section of the population diagram shows the signal traffic for four directly consecutive call requests. Each message signal type is shown by a representative. Along the axis for the message type representative, the message signals are marked, according to the occurrence thereof at the test point along the respective horizontal axis. The message signals are processed successively by the switching units participating in the call setup. The above signaling traffic does not involve any delay extending beyond the usual response times for such systems.

Section B-F shows signal traffic, for, for example, 32 call requests.

In Section B-C, 8 message signals of the message type SETUP are transmitted by the SOURCE module. All 8 SETUPs are processed and redirected by the SWITCH module. Only 4 of the aforementioned 8 setups are answered by the DESTINATION module with the message signal of the message type CONNECT. The remaining 4 CONNECT message signals are only answered in the following active period of the system in section C-D. The first 4 message signals of the message type CONNECT are confirmed by the SWITCH with CONNECT_ACK and are simultaneously redirected in the direction of the SOURCE. It is only in section F-G that the SOURCE first sends a CONNECT_ACK message signal in response to the aforementioned 4 CONNECT message signals when all the SETUPs have already been transmitted.

Sections C-D, D-E, E-F are identical to section B-C. This display layout offers the advantage that irregularities can be detected immediately as a result of the layout, and focused troubleshooting can already be set in motion.

This display can then be processed in the subsequent population sample analysis module PAM. Thus software incorporated therein can determine the total number of lines (message signals) at all levels and provide notification where all are present. In FIG. 5 the number of message signals originally transmitted was equal to 40, that is, no message packets were lost. The burst of 40 SETUP message signals is transmitted by the source module not in a single burst, but is emitted by the source in a plurality of short bursts of 8 SETUPs, interspersed by quiescent periods of about 0.7 seconds. In section B-F, between SOURCE and SWITCH the number of SETUPs, CONNECTs and CONNECT_ACKs is not the same, and the destination module responds to 8 message signals of the message type SETUP with only 4 CONNECTs and 0 CONNECT_ACK message signals. In section B-F, between SWITCH and DESTINATION, the number of SETUPs, CONNECTs and CONNECT_ACKs is not the same as one would expect and only 4 CONNECTs and 4 CONNECT_ACKs are emitted in response to 8 SETUPs. This diagram can then be interpreted using software or by an expert.

By looking at the diagram, irregularities can thus be observed in a simple manner. Such irregularities can consist in the absence of individual message types and/or in a duplication of message types and/or in a delayed arrival of message types and likewise in a repetition of message types having the respective identification numbers ID.

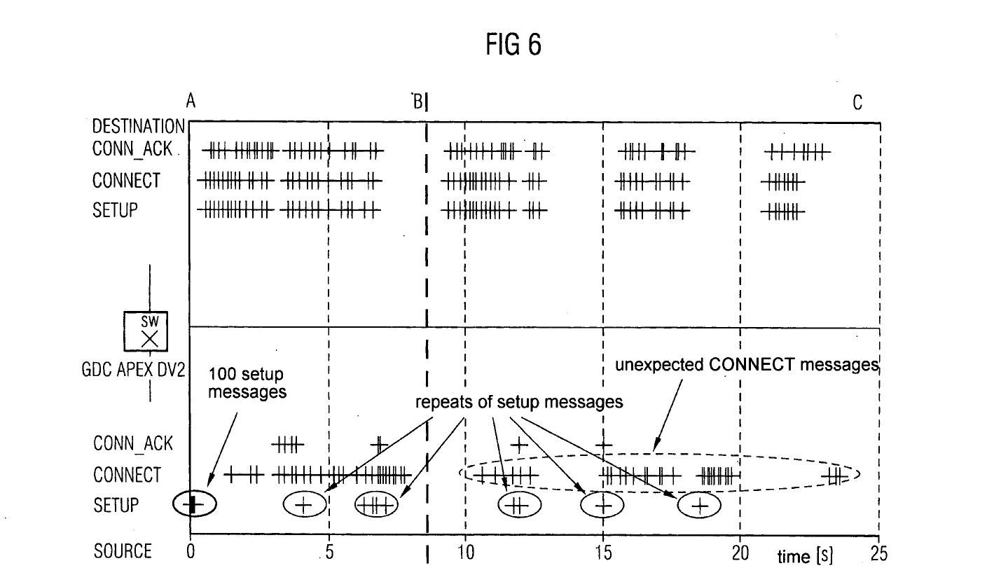

FIG. 6 shows a further metapopulation diagram MPD (2;1;3;1). As shown in FIG. 5, a message signal of, for example, 100 directly consecutive call requests is combined in one burst. The communications link between source and destination runs via a switch SW. A switch having a reduced processing rate is used here in order to make the application of the subject of the invention more apparent. This diagram highlights a bottleneck in the message signal processing in the connection setup pathway, which here is in the network element SWITCH SW. Out of the 100 Call requests, 25 message signals of the message type SETUP are redirected by the SWITCH in section A-B, the remaining setups have to request a call setup once again. After expiry of a time limit that is built into the SOURCE module, the SETUPs that have gone astray and were not acknowledged with CONNECT during this period are again sent by the SOURCE module to the DESTINATION module. This ensues as shown in five consecutive time periods. The DESTINATION module responds to each SETUP received with the message signal of the message type CONNECT, which is also acknowledged by the SWITCH module with the message signal of the message type CONN_ACK. All the CONNECT message signals that are returned to the SOURCE module via the SWITCH in section B-C arrive outside the predetermined time window, which is why they are not accepted and are not acknowledged with CONN_ACK. After a software-based sample analysis it is observed inter alia that a total of 100 message signals of the message type SETUP are generated at the beginning of the connection process, but 200 SETUPs have been found by the end of the process, that is, message signals are repeated here. In sections A-B (or A-C), between SOURCE and SWITCH, the number of SETUP, CONNECT and CONNECT_ACKs is not the same and for 100 (or 200) SETUPs, the system delivers only 25 (or 53) CONNECTs and 6 (or 26) CONNECT_ACKs.

All the CONNECT message signals in section B-C arrive at the SOURCE too late, that is, after the expiry of a built-in time limit, and therefore no CONNECT message signal is acknowledged with CONN_ACK.

In the population sample analysis module PAM it is observed that a total of 26 out of 100 calls have been processed. This figure is derived from the number of CONN_ACK message signals that were transmitted by the SOURCE module.

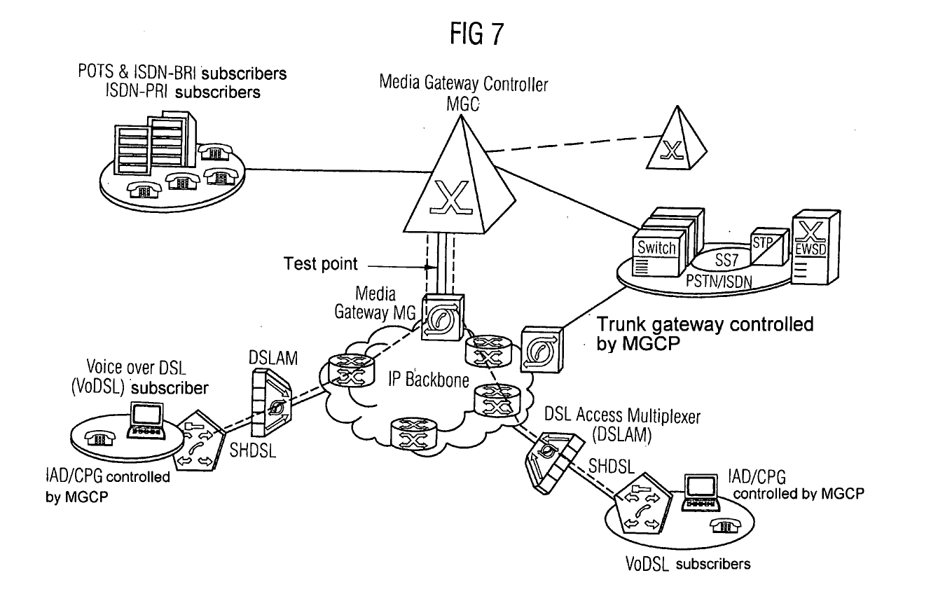

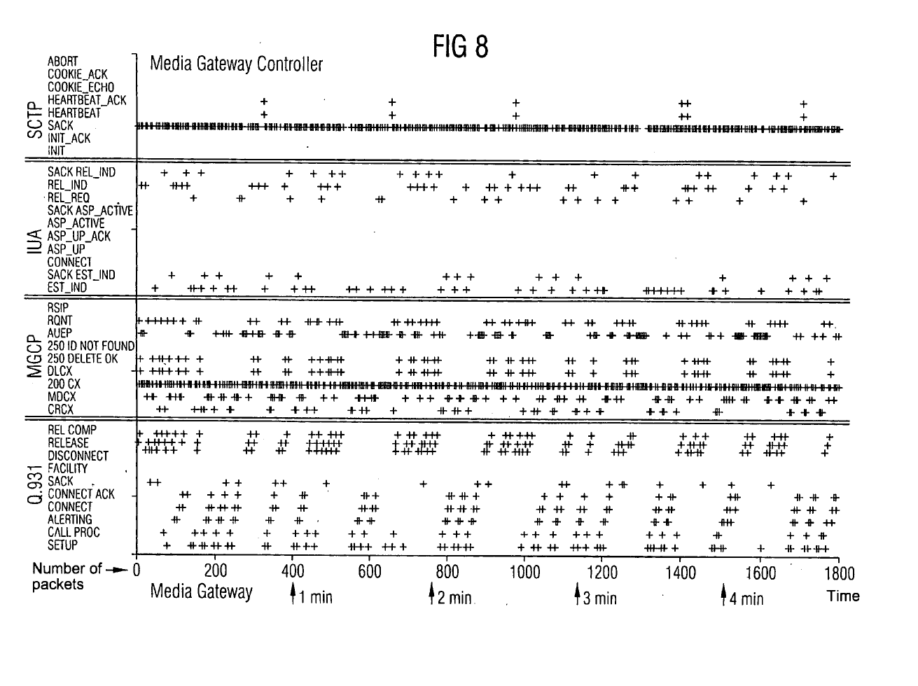

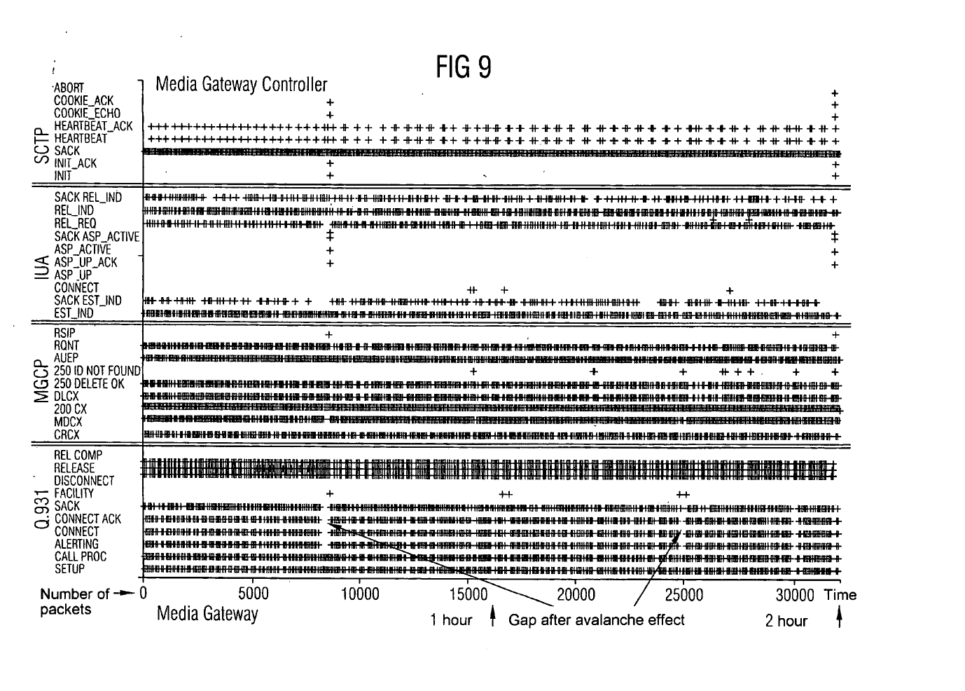

FIG. 7 shows a section of a network topology. This network section shows telecommunication pathways between telecommunication subscribers via an Internet protocol IP-based network. In this example, the respective telecommunication devices are connected to a respective Integrated Access Device IAD. Said Integrated Access Devices IADs are physically connected with twin copper wires in the conventional manner but using Symmetrical High-Speed Digital Subscriber Line Technology SHDSL to a Digital Subscriber Line Access Multiplexer DSLAM and are then further connected via the backbone of the IP network. A central network element known as a Media Gateway Controller MGC is arranged in the IP network. Said controller coordinates communication for call setup/cleardown between the final subscribers. FIG. 7 also shows a test point between the Media Gateway MG and the Media Gateway Controller MGC. Said test point allows tracking of signal traffic between the aforementioned Voice over Digital Subscriber Line DSL VoDSL subscribers and the Media Gateway Controller MGC. The signal traffic at this point is so intense that it is impossible to give an overview thereof using known diagrams. As a result of the high volume of signal traffic, it is advantageous to use a metapopulation diagram MPD (x;y;u;v) as shown in FIGS. 8 and 9.

To track the signal traffic between the final subscribers and the Media Gateway Controller MGC, FIG. 8 and FIG. 9 show the signal traffic within the main protocol types. The test point is located between the Media Gateway MG and the Media Gateway Controller MGC. Said test point provides access to all the data packets that are processed via the Media Gateway Controller MGC.

FIG. 8 and FIG. 9 show two metapopulation diagrams MPD (1;4;10;1) with different time windows.

The vertical axes in FIGS. 8, 9 show signal traffic within protocols at an interface (x=1) between Media Gateway MG and Media Gateway Controller MGC. Said protocols can be, for example, protocol types (y=4) Q.931 for ISDN signaling, MGCP for Media Gateway Control Protocol, IUA for ISDN Q.921 User Adaptation and SCTP for Stream Control Transmission Protocol. The respective message types (here for example, a maximum of u=10) are listed for the respective protocol types. Sublevels for tx and rx are not included in order to give an overview (v=1).

The message types for the four protocol types are determined during setup/cleardown of the communication pathway at the given test point and are shown in FIGS. 8, 9. Only one population level is shown for each of the message types. This has the advantage that it remains possible to have an overview of the signal traffic despite the fact that 1800 and 32000 data packets are monitored in FIGS. 8 and 9 respectively.

FIG. 8 shows a 5-minute section of 24-hour continuous operation. With this signal traffic there is not any delay extending beyond the usual response times for such systems.

The message types SETUP, CALL PROCEEDING (CALL PROC, ALERTING, CONNECT, CONNECT ACKNOWLEDGE, SETUP ACKNOWLEDGE (SACK), FACILITY, DISCONNECT, RELEASE, RELEASE COMPLETE (REL COMP) are shown for the protocol type Q.931.

The message types CRCX (Create Connection), MDCX (Modify Connection), DLCX (Delete Connection), ACKNOWLEDGE (200 OK, 250 DELETE OK, 250 ID NOT FOUND), AUEP (Audit Endpoint), RQNT (Request Notification), RSIP (Restart In Progress) are shown for the protocol type MGCP.

The message types EST_IND (Establishment Indication), SACK EST_IND, CONNECT, ASP_UP (Application Server Process UP), ASP_UP_ACK, ASP_ACTIVE, SACK ASP_ACTIVE, REL_REQ (Release Request), REL_IND (Release Indication), SACK REL_IND are shown for the protocol type IUA.

The message types INIT, INIT_ACK, SACK, HEARTBEAT, HEARTBEAT_ACK, COOKIE_ECHO, COOKIE_ACK, ABORT are shown for the protocol type SCTP.

FIG. 9 shows the message signals within a 2-hour time window taken from a 24-hour continuous operation. Along the message type representative the time stamps for the message signals are recorded according to when the signals arrive at the test point. The message signals are successively processed by the units involved in the call setup. The figure also shows the frequency and distribution of the message types generated for the respective protocol type.

The setting of the time window is then optimized in the population sample analysis module PAM in order to provide a clearer display. This can be for example 5 minutes, 30 minutes, 1 hour, 2 hours, or 24 hours, etc., such that it becomes possible to detect irregularities in the respective diagram.

A software analysis is carried out as follows:

In a first step, the time window ZF is set at ZF=24 hours. Then a sample analysis is carried out as shown for FIGS. 4, 5 and 6. The number of message signals and the time limits are taken into account therein. If there is an error, then the time window is reduced successively, to, for example, ZF=2 hours. Then a fresh sample analysis is carried out. If there is an error, then the time window is further reduced to ZF=1 hour, 30 minutes, 10 minutes, 5 minutes, 1 minute and a fresh sample analysis is carried out.

Unlike FIG. 8, FIG. 9 shows signal traffic over a period of 2 hours. A total of 32000 data packets were monitored in this period. After a sample analysis carried out in the population sample analysis module PAM, as described above, it is observed that the loss of packets occurs once an hour. The 5-minute section shown in FIG. 8 is error-free. In the 2 hour section in FIG. 9 there is an error, however. The population sample analysis module PAM sends notification that some packets have been lost in the ISDN Signaling Q.931, such as ALERTING and CONNECT, for example. A person skilled in the art will then be able to determine how a short-term avalanche effect came about in the case of the message signals. The signals are then repeated by the system, which again leads to a short network failure lasting 10-15 seconds. FIG. 9 clearly shows the signal failure that occurs and the effects thereof on the protocol levels.

With the aid of one or a plurality of metapopulation diagrams, such a bottleneck can be localized and analyzed in a first step. Further steps, such as, for example, a reduction in the time window that is being observed, also allows the comprehension of message signals across the protocol levels.

1.-10. (canceled)

11. A switching device for displaying at least one item of data information extracted from a data stream, the device comprising:
a decoding module extracting protocol types, message types, and/or identification data;
a clock extraction module for extracting time stamps;
a direction detection module for detecting received and transmitted data;
a population module having an assignment module which uses a respective message type representative for identical message types from a plurality of call requests or data streams, wherein a time stamp assigned to the respective message type is assigned to the message type representative; and
a population diagram module for displaying the respective message type representatives together with the time stamps.

12. The switching device according to claim 11, wherein the assignment module is designed such that the respective message types are provided with identification numbers and time stamps pertaining thereto and that said numbers and marks are linked with a message type representative.

13. The switching device according to claim 11, wherein the assignment module is designed such that message type representatives pertaining to one or a plurality of protocol types can be assigned.

14. The switching device according to claim 12,cwherein the assignment module is designed such that message type representatives pertaining to one or a plurality of protocol types can be assigned.

15. The switching device according to claim 11, wherein a population sample analysis module is designed such that, protocol types, message types, time stamps and identification numbers are acquired statistically and can be shown according to how they occur during a call setup and a link disconnection.

16. The switching device according to claim 12, wherein a population sample analysis module is designed such that, protocol types, message types, time stamps and identification numbers are acquired statistically and can be shown according to how they occur during a call setup and a connection clearing.

17. The switching device according to claim 13, wherein a population sample analysis module is designed such that, protocol types, message types, time stamps and identification numbers are acquired statistically and can be shown according to how they occur during a call setup and cleardown.

18. The switching device according to claim 11, wherein the population sample analysis module is designed such that the beginning of a time period of a time window can be determined by a trigger signal and the duration of the time period can be set.

19. The switching device according to claim 11, wherein the data stream is formed from one or a plurality of data packets.

20. A method for displaying at least one item of data information extracted from a data stream, the method comprising:
providing a decoding module for extracting of protocol types, message types and identification data;
providing a clock extraction module for extracting time stamps;
providing a direction detection module for detecting received and transmitted data;
using a respective message type representative for identical message types from a plurality of call requests or data streams;
assigning a time stamp assigned to the respective message type to said message type representative; and
displaying the respective message type representatives together with the time stamps.

21. The method according to claim 20, wherein the respective message types are provided with identification numbers and time stamps pertaining thereto and that said numbers and marks are linked to a message type representative.

22. The method according to claim 20, wherein message type representatives pertaining to one or a plurality of protocol types can be assigned.

23. The method according to claim 20, wherein protocol types, message types, time stamps and identification numbers are determined statistically and can be shown according to how they occur during a call setup and cleardown.

24. The method according to claim 20, wherein the beginning of a time period of a time window can be determined by a trigger signal and the duration of the time period can be set.
